(19) United States
(12) Patent Application Publication
(10) Pub. No.: US 2022/0400601 A1
(43) Pub. Date: Dec. 22, 2022

(54) Agricultural Seed Conveyor with Low Pressure Liquid Treatment System

(71) Applicant: KSi Conveyor, Inc., Sabetha, KS (US)

(72) Inventors: Dominic E. Meyer, Sabetha, KS (US); Jason P. Kaeb, Sabetha, KS (US); Matthew J. Edelman, Sabetha, KS (US); Paul A. Kaeb, Sabetha, KS (US)

(73) Assignee: KSi Conveyor, Inc., Sabetha, KS (US)

(21) Appl. No.: 17/753,023

(22) PCT Filed: Jul. 21, 2021
(86) PCT No.: PCT/US2021/070916

§ 371 Date: Feb. 15, 2022

Related U.S. Application Data
(60) Provisional application No. 62/706,356, filed on Aug. 11, 2020.

(51) Int. Cl. A01C 1/08; B65G 15/08; A01C 1/06

(52) U.S. Cl. CPC A01C 1/08; B65G 15/08; A01C 1/06; B65G 2201/042

(57) ABSTRACT

A liquid treating conveyor system that can apply a metered liquid treatment to a metered stream of seed within the conveyor, with either the rate of the seed or treatment fluid regulated. The conveyor has a curved structure. A belt conformed to the curved structure carries a bed of seed through the conveyor. A liquid dispenser distributes a treatment across the seed bed. The liquid may enter the liquid dispenser at low pressure for low shear applications. Liquid dispensers may be spaced apart along a portion of the conveyor. Gas outlet ports and mixing baffles may be disposed within the conveyor. A liquid channel may be disposed within a mixing baffle to direct flow of treatment from the liquid port to an outlet port in contact with the seed bed.

### CROSS REFERENCES

This application claims priority of U.S. Provisional Application No. 62/706,356 filed on 11 Aug. 2020.

### TECHNICAL FIELD

The present disclosure relates to an apparatus and method for dispersing liquid within a trough conveyer configured to mix and condition seed during transport.

### BACKGROUND

Agricultural commodities such as seeds may be batch treated in bulk treatment systems. Before delivery to a seed planter, the wet, freshly treated seed is mixed and dried. Seed treatment systems may incorporate a drum for mixing and drying. After treatment, treated seeds may be transported by seed handling equipment such as conveyors. Conveyors can move seed at steep angles to deposit seed for storage, transport, or other applications. Seed can be moved with very little damage and more efficiently at steeper angles with belt conveyors. Belt conveyors utilize a continuous belt to transport seed to the intended destination.

Agricultural seeds are often treated and protected with insecticides, fungicides, inoculants, nutrients, and other compositions before planting. These seed treatments may be applied by spraying a liquid composition over the surface of seed, which allows a smaller quantity of seed treatment composition compared with traditional field application of treatment fluids.

### SUMMARY

In general, the disclosure features an agricultural belt conveyor having a curved or tubular structure. The belt conveyor may have a lower portion that is the curved structure, an upper portion covering the lower portion, and an interior portion between the lower portion and the upper portion. The belt conforms to the curved structure, carrying a bed of seed or agricultural products through the conveyor. A liquid dispenser distributes a liquid across the bed of seed or agricultural products during transport through the conveyor. The liquid may be at a pressure of less than 2,000 millibars (mbar) or 200,000 pascals (Pa) (approximately 30 pounds per square inch (psi)).

In a limited shear situation, the liquid dispenser may be selected from a slotted tube, a drop nozzle, a rotary dispenser, an ultrasonic (US) spray nozzle, or a non-shearing delivery mechanism. The liquid dispenser may have a tube extending across a width of the curvilinear structure. The tube of the liquid dispenser may have a lower portion. A slot may be disposed in the lower portion of the tube. Slots may extend along the length of the tube. An injection or liquid port may pass through the upper portion of the belt conveyor. Liquid ports may be spaced apart along a portion of the conveyor. The upper portion may include a lid that is removable, where the liquid ports pass through the lid. The liquid ports deliver a liquid or treatment to the interior portion of the conveyor. A check valve may be positioned vertically above the belt conveyor. The check valve may be connected to the liquid dispenser through the injection port. The liquid dispenser may receive the liquid at a pressure of less than 10 psi or within a range of between 2 psi to 5 psi. A distribution manifold outlet may be fluidly connected to the liquid ports. A mixing manifold may be fluidly connected to the distribution manifold. The mixing manifold may fluidly connect a first treatment source and a second treatment source to the first distribution manifold. A static mixer may be positioned between the mixing manifold and distribution manifold to induce further mixing prior to distribution by the first distribution manifold.

The agricultural belt conveyor may have a conveyance structure. A mixing baffle and a gas port, including a gas inlet port and a gas outlet port may be disposed within the conveyance structure. The conveyance structure may be a curved structure. Gas ports may be disposed within the conveyance structure downstream or upstream of a liquid dispenser. Gas ports may be disposed within the conveyance structure at a lower head end or upper tail end of the conveyor. Alternatively, gas ports may be disposed within the conveyance structure upstream or downstream of a mixing baffle. The gas ports may be longitudinally spaced apart and laterally alternating within the conveyance structure. Mixing baffles may be mounted within the conveyance structure downstream or upstream of a liquid dispenser or mounted both downstream and upstream of the liquid dispenser. Mixing baffles may be positioned within the curved structure at a lower head end or upper tail end of the conveyor. Alternatively, mixing baffles may be disposed within the conveyance structure downstream or upstream of a gas port or disposed both downstream and upstream of the gas port. The mixing baffles may be longitudinally spaced apart and laterally alternating within the conveyance structure. The mixing baffles may be mounted to a top portion or the lid of the conveyor. The mixing baffles may be mounted to a side portion of the conveyor. The mixing baffles may be installed in the inner portion of the conveyor in an alternating manner. The mixing baffles may be used to direct agricultural products within the interior portion of the conveyance structure. A liquid channel may be disposed within a mixing baffle. Alternatively, or additionally, a liquid channel may be disposed outside a mixing baffle. The liquid channel may be secured to a backside of the mixing baffle. The liquid channel fluidly connects with a liquid port allowing liquid to flow from outside the conveyor, through the liquid port, through the liquid channel, and into the interior portion of the conveyance structure. In the example where a liquid channel is disposed within a mixing baffle, the liquid flows through the liquid channel to a liquid outlet port positioned on the mixing baffle. The liquid then exits the mixing baffle to contact the seed or agricultural product.

The belt conveyor can be used for treating seed. A metered stream of seed is provided to the belt conveyor. A first metered liquid treatment is applied to the metered stream of seed within the belt conveyor. The metered stream of seed may be regulated based on the rate of the first metered liquid treatment. Alternatively, the first metered liquid treatment may be regulated based on the rate of the metered stream of seed. The metered stream of seed may be mixed in the belt conveyor with the mixing baffles positioned within the conveyor. The metered stream of seed may be in turbulent backflow when the first metered liquid treatment is applied. The first metered liquid treatment may be provided to a liquid dispenser at less than 30 psi. A second treatment source may be connected to a portion of the belt conveyor. The second treatment may be injected in the metered stream of seed with a second outlet port.

### DESCRIPTION OF THE DRAWINGS

Aspects are illustrated by way of example, and not by way of limitation, in the accompanying drawings, wherein:

FIG. 1 shows a side-perspective drawing of a liquid treating conveyor system having a liquid treatment source and a controller;

FIG. 2 shows a cross-section of a conveyance structure of a liquid treating conveyor system, showing a curvilinear portion holding a seed bed being exposed to a seed treatment fluid;

FIG. 3 shows a top-side perspective of a liquid treating conveyor system having mixing baffles and gas inlets and outlets, with the lids removed to show an interior portion of the conveyor;

FIG. 4 shows a top side perspective of a liquid treating conveyor system with fluid connections extending through the attached lids in a lower head end and gas inlets and outlets in an upper tail end;

FIG. 5 shows a fluid manifold connected to the fluid connections extending through lids of a liquid treating conveyor system;

FIG. 6 shows a bottom-side perspective of a slotted tube dispenser;

FIG. 7 shows a bottom-side perspective of a slotted tube dispenser;

FIG. 8 shows a bottom-side perspective of a slotted tube dispenser;

FIG. 9 shows a bottom-side perspective of a drop tube dispenser;

FIG. 10 shows a bottom-side perspective of a rotary dispenser;

FIG. 11 shows a bottom-side perspective of a spreader nozzle;

FIG. 12 shows a top-side perspective of a mixing baffle having a fluid channel and outlet ports; and

FIG. 13 shows a flow chart of a method for applying treatment fluid to a stream of seed using a conveyor.

### DETAILED DESCRIPTION

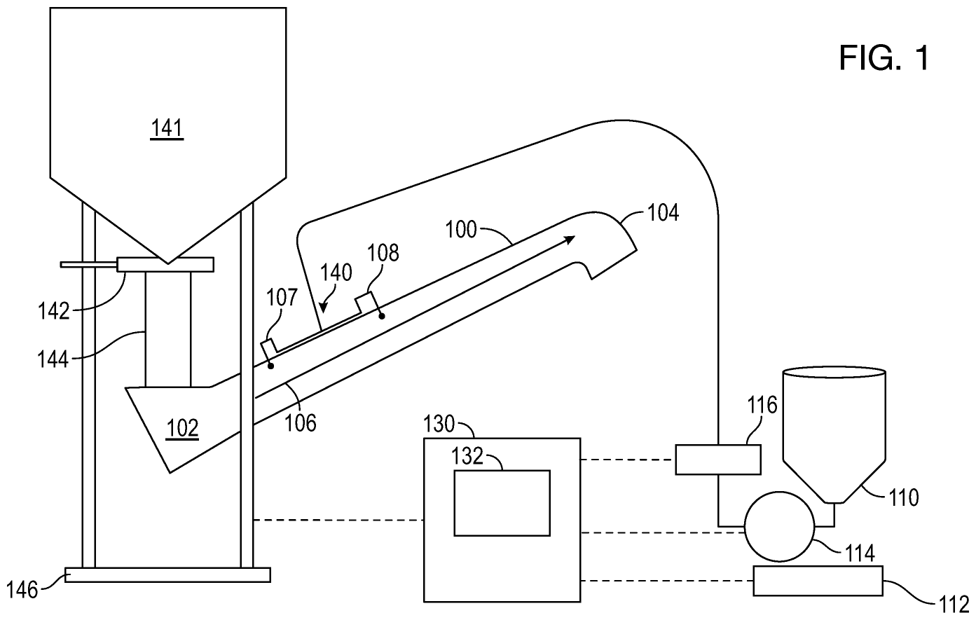

A liquid treating conveyor system is shown in FIG. 1. The liquid treating conveyor system can apply a metered quantity of liquid treatment to a metered quantity of seed. Conveyor 100 receives a metered supply of seed from hopper 141. The liquid seed treatment is applied as the seed is conveyed through the conveyor 100, from the lower head end of the conveyor 102 to the upper tail end 104 of the conveyor. The seed flows within the conveyor 100 along a seed flow path shown by directional arrow 106.

The conveyor has a liquid injection section 140. Liquid injection section 140 is shown having two liquid ports 107, 108 through a top portion of the conveyor that are connected to respective liquid dispensers (discussed below) within the conveyor 100. The liquid ports 107, 108 are connected to a seed treatment source 110. The seed treatment source 110 contains a first liquid seed treatment.

A control system 130 receives various measured signals and transmits various control signals to operate the equipment and regulate the flow rates. Related to the flow of liquid, the control system 130 receives a fluid signal from the meter 116 and a mass signal from scale 112. Related to the flow of seed, the control system 130 receives a mass signal from scale 146. The control system 130 may be in electric communication with the various air valves, liquid flow regulators (proportional valves), fluid pumps, and seed flow regulators.

The control system 130 generates various control signals. The seed flow is illustrated as regulated using a variable position gate 142, which may be controlled electronically or pneumatically by the control system 130 in response to a mass measurement over time by scale 146. The control system 130 may generate a control signal for pump 114. Pump 114 receives the control signal and opens in response to the control signal to achieve a selected flow rate of fluid. The control system 130 monitors and regulates the flow rates of the various seed and liquid sources. A transition element 144 is illustrated for ease of presentation. The metered stream of seed may flow through any number of elements that maintain the metered flow rate prior to reaching conveyor 100, including a seed treatment applicator, conditioning chamber, seed ladder, other conveyors, or any combination thereof. The control system 130 may include a human-machine interface 132, such as a touch screen, to allow the operator to change settings, enter and select orders, enter and select recipes, and print and export order reports and receipts.

The operator may apply a variety of liquid seed treatment. Liquid seed treatment may be an insecticide, fungicide, inoculant, nutrient, lubricant, and other compositions or combinations thereof that are applied to the seed before planting. These seed treatments are commonly applied to the surface of the agricultural seed by spraying a liquid composition to the seed surface. On-seed application provides a smaller quantity of seed treatment composition than the traditional field application of treatment fluids. It is possible to apply multiple layers of seed treatment and conditioning within zones of the conveyor. Alternatively, a plurality of conveyors may be positioned and made operable together to apply seed treatment and conditioning during multiple passes of the metered stream of seed. For example, a fungicide may be applied, dried, and then a nutrient or lubricant is added as a second coat. One or more coats of a seed treatment can be added by a seed producing company, a seed dealer, or a farmer.

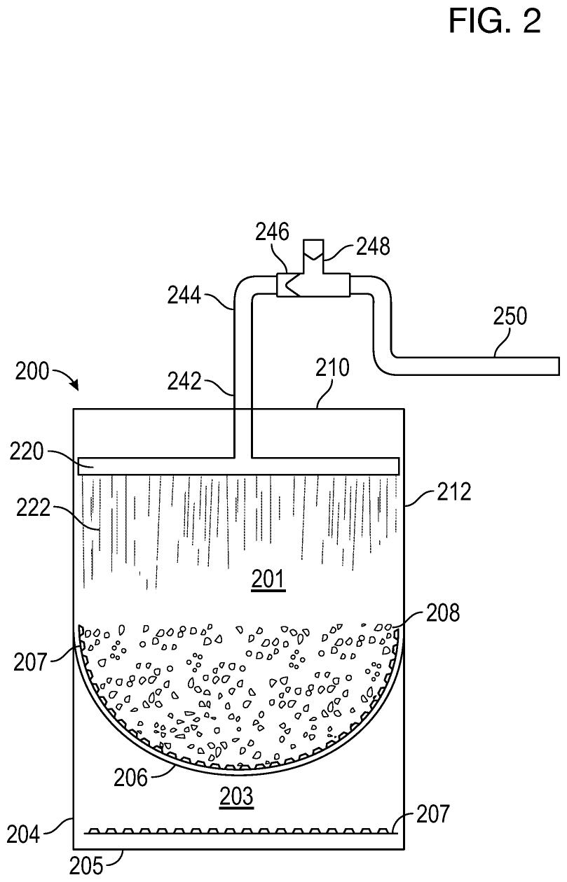

The seed—or other particulate material—208 is carried on the belt 207 through a cavity—or interior portion—201 of the conveyance structure 200. A trough may be disposed on a lower side of the interior portion 201 through which the particulate material flows. The trough may be a curvilinear structure 206, as shown in FIG. 2. The curvilinear structure 206 may be disposed above a lower trough 203 of the conveyance structure 200, through which a portion of the belt 207 that is not carrying particulate material travels. The lower trough 203 may be curvilinear or may not be curvilinear. When the belt 207 travels through the curvilinear structure 206, the belt 207 takes on a similar curvilinear cross section. The belt 207 conforms to the curvilinear structure 206 when the belt moves through a transition portion of the conveyor into the curvilinear structure 206. The particulate material 208 is carried on the belt 207 as the belt 207 is driven upon the curvilinear structure 206 with a driven roller. Conforming the belt 207 to the curvilinear structure 206 provides a seed bed depth for increased transportation rates, provides side support for more aggressive mixing, and allows for complete cleanout of particulate material 208 or other matter at the head end of the conveyor.

Liquid is introduced into the interior portion 201 of the conveyance structure 200 through an injection port 242 in a top portion 210 of the conveyance structure 200. A liquid dispenser 220 is disposed within the conveyance structure 200. The liquid dispenser 220 dispenses a liquid 222 across a diameter of the curvilinear structure 206, which covers the width of a bed of particulate material 208, such as a seed bed. The injection port 242 may be a standard plumbing fitting, disposed through a lid or other top portion 210 or side portion 212, 204 of the conveyance structure 200. The liquid dispenser 220 is fluidly connected to the injection port 242, which may comprise a press fitting, screw fitting, or other suitable fluid connection.

The liquid is delivered to the liquid dispenser 220 from the seed treatment source (as shown in FIG. 1) through a fluid connection. The fluid connection may comprise an elevated portion. The elevated portion may have a riser 244 extending upwardly from the injection port 242. The riser 244 may be connected to a tee fitting 246. An air vent 248, such as a one-way duck-bill check valve, may be installed in an upper portion of the tee fitting 246. The liquid line 250 proceeds to the seed treatment source 110 at a lower elevation than the air vent 248. In this configuration, the air vent 248 allows treatment liquid to drain between the air vent 248 and liquid dispenser 220. Having a check valve vertically above the conveyor may provide quicker draining at the end of a treatment cycle, minimize the amount of treatment liquid that flows through at the end of a treatment cycle, and allows for a more complete drainage out of the dispenser to prevent buildup. The bottom 205 of the conveyance structure 200 may incorporate a drain or catch basin to direct the flow of unapplied liquid treatment for capture.

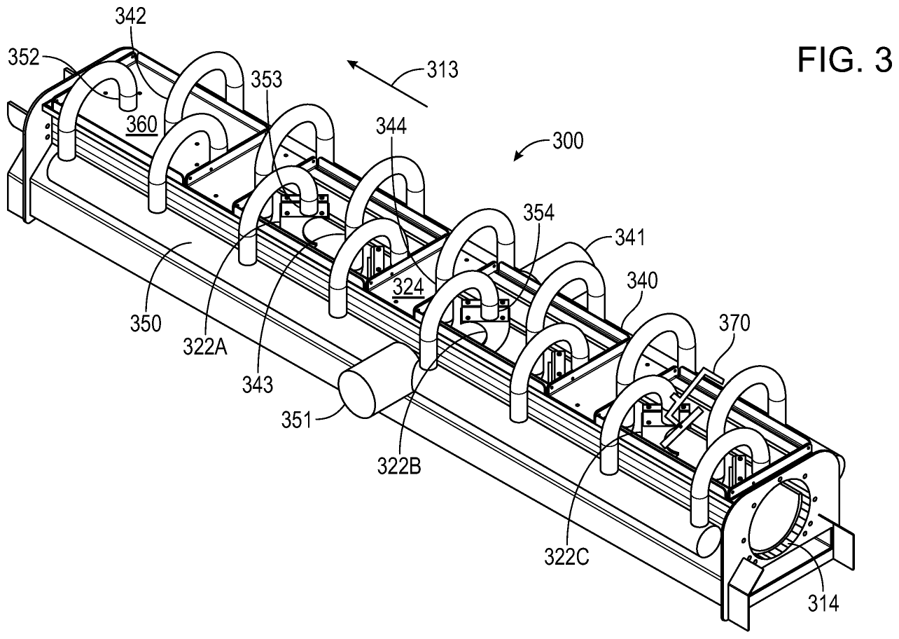

A liquid treating conveyor system is shown in FIG. 3 with a mixing apparatus and a gas conditioning apparatus. A portion of a conveyor 300 is shown in FIG. 3. A liquid dispenser 370 is shown in an upstream side of the conveyor portion. Arrow 313 shows the direction of movement of the seed within the conveyor portion. The stream of seed enters the portion of the conveyor 300, in a seed bed carried by the belt and conformed to the curvilinear portion 314. A mixing baffle may be positioned upstream of the liquid dispenser 370 in order to disrupt the seed bed. The liquid dispenser 370 releases a curtain or other flow of liquid upon the seed bed. The seed continues to travel, in the direction of arrow 313, and encounters mixing baffles that spread the liquid treatment by contacting individual seeds with each other. Gas discharge (gas inlet) ports may introduce a gas, such as conditioned air, into the interior portion of the conveyor. Gas removal (gas outlet) ports may remove humid air from the interior portion of the conveyor. A High Efficiency Particulate Air (HEPA) filter may be installed in each of the gas removal ports to trap particulate material for removal from the gas manifold system.

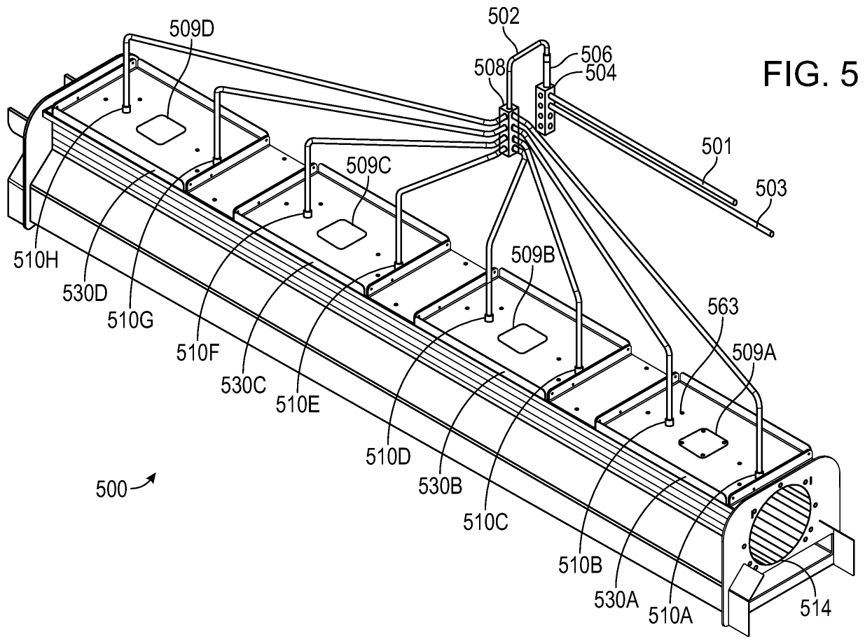

Lid 360 on the downstream side of the conveyor 300 is shown in place, all other lids are not shown to allow the interior portion of the conveyor to be viewed. The mixing baffles, which would be mounted to the lids (see mounting point 563 in FIG. 5 as an example), are shown statically in place, as they would be when installed with the lids. A truss 324 that extends between a first lateral side of the conveyance structure and a second lateral side of the conveyance structure provides a connection point for attaching a lid.

Mixing baffles 322A, 322B, 322C may be incorporated into a belt conveyor to mix seed—or other particulate material—being transported on the belt. Inserting a plurality of mixing baffles into the stream of the particulate material induces a turbulent backflow of the particulate material. Turbulent backflow of seed may mix seed during belt conveyor transference. Turbulent backflow of seed may occur adjacent to an upstream face of the mixing baffle, a downstream face of the mixing baffle, or adjacent to both the upstream and downstream faces of the mixing baffle. Turbulent backflow of seed adjacent to the upstream face of the mixing baffle occurs when downstream transference of seed ricochets seed off the upstream face of the mixing baffle. Turbulent backflow of seed adjacent to the downstream face of the mixing baffle occurs when gravity causes seed to fall backwards towards the downstream face of the mixing baffle. In the case of wet, freshly treated agricultural seed, this backflow causes a mixing, polishing, and drying of the treatment upon the plant seed. The mixing distributes the seed treatment into an even coat by rubbing the individual seeds of the seed flow stream together. The belt movement generates the downstream seed stream flow. The seed stream flow may be divided, mixed, and partially redirected upstream with the static mixing baffles. The mixing baffles are more fully described in U.S. patent application Ser. No. 16/947,035 filed on 15 Jul. 2020 and Ser. No. 16/947,334 filed on 29 Jul. 2020, the disclosures of which are incorporated by reference herein.

A gas conditioning apparatus is shown in FIG. 3, with a first gas manifold 340 and a second gas manifold 350. The conveyor may be connected to a pressurized gas source to induce positive pressure, a vacuum to induce negative pressure, or a combination thereof for inducing positive and negative pressure within the conveyor atmosphere. Gas manifolds 340, 350 each have a plurality of gas ports that enter through an upper portion of the conveyor 300. As particulate material passes through the conveyor 300, the conditioning apparatus effectuates drying and conditioning of the stream of particulate material. The first gas manifold 340 may be made operable by at least one manifold inlet port 341. A plurality of gas discharge ports 342, 343, 344 may introduce conditioned air at any point along the longitudinal length of the conveyor 300 through the first gas manifold 340. Similarly, a second gas manifold 350 may be made operable by at least one manifold outlet port 351. A plurality of gas removal ports 352, 353, 354 may remove air, including one or more of debris, heat, and humidity, at any point along the longitudinal length of the conveyor 300 through the second gas manifold 350. Conditioned air may assist in the cooling and drying of freshly treated seed by introducing lower humidity gas relative to the interior portion of the conveyor 300. The vacuum source may assist in the drying of freshly treated seed by removing humid gas from the interior portion of the conveyor 300. A conditioning apparatus is more fully described in U.S. patent application Ser. No. 16/947,334 filed on 29 Jul. 2020 and PCT application PCT/US20/70324 filed on 29 Jul. 2020, the disclosures of which are incorporated by reference herein.

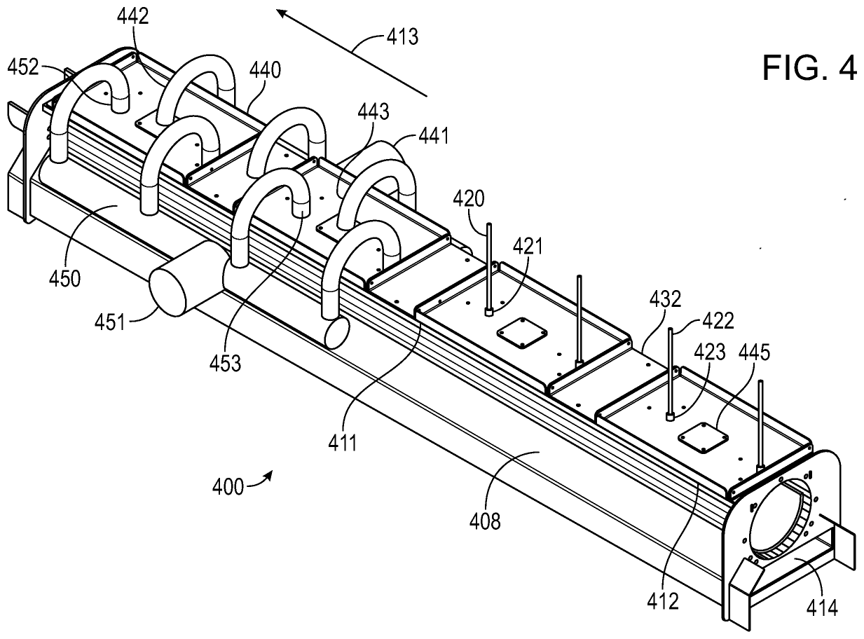

Another gas conditioning apparatus, similar in operation to the previously discussed gas conditioning apparatus, is shown in FIG. 4. The gas conditioning apparatus shown in FIG. 4 has a first gas manifold 440 and a second gas manifold 450. With the lids installed, a plurality of fluid lines 420, 422 may be connected to a plurality of injection ports 421, 423. The plurality of injection ports 421, 423 that pass through the lids 411, 412 allow treatment, or other fluid, to be injected at a lower head end, or treating zone, of the conveyor 400. This configuration may allow a conditioning or drying zone to be located along a portion of the longitudinal length of the conveyor 400 downstream of the treating zone. A first gas manifold 440 may be made operable by at least one manifold inlet port 441. A plurality of gas discharge ports 442, 443 may introduce conditioned air at an upper tail end of the conveyor 400 through the first gas manifold 440. Similarly, a second gas manifold 450 may be made operable by at least one manifold outlet port 451. A plurality of gas removal ports 452, 453 may pass through the lids at the upper tail end of the conveyor 400. The conveyance structure includes the curvilinear portion 414 and a side support 408. Seed flows through conveyor 400 in the direction of arrow 413. The lids may have an access port 445, or a plurality of access ports, to allow other material, sensors, or devices to be inserted therethrough. Truss 432 extends laterally across an upper portion of the conveyor 400, providing structural support as well as a place to secure lids 411, 412.

Multiple liquid sources can be brought in to deliver to multiple dispensers longitudinally spaced apart along a portion of a conveyor 500, as shown in FIG. 5. A distribution manifold 508 is connected to a mixing manifold 504 and a static mixer 506 via fluid connection 502. The mixing manifold 504 may have a plurality of ports for connecting fluid connections 501, 503 to multiple liquid treatment sources (not shown). The liquid treatment sources may be similar in set up to the liquid treatment source shown in FIG. 1. Treatments entering the mixing manifold 504 are combined into a single stream. The mixing manifold 504 may be connected to a static mixer 506, where multiple treatment liquids are blended together. The static mixer 506 may blend multiple treatment liquids into a single stream. The static mixer may be an inline static mixer, which creates a mixing action as the liquid moves through the static mixer. Static mixers incorporate a turbulence-inducing mixing element in the liquid flow path. These turbulence-inducing mixing elements can have specific shapes and sizes—such as a blade, helix, or wafer—to efficiently cause the liquids to blend. The specific design of the static mixer would depend on the characteristics of the liquids to be blended in a specific application. The static mixer may be oriented vertically, as illustrated. Liquid flows up through the static mixer, through a fluid connection, and on toward the conveyor.

The mixing manifold 504 may be connected to a distribution manifold 508 downstream of the static mixer 506 in order to bring a combined stream to multiple dispensers longitudinally spaced apart along the conveyor 500. Injection ports 510A, 510B, 510C, 510D, 510E, 510F, 510G, 510H are shown disposed through lid sections 530A, 530B, 530C, 530D of the upper portion of the conveyor 500. Alternatively, the injection ports may be disposed below or through the side of the curvilinear structure 514. A plurality of liquid dispensers mounted within the interior portion of the conveyor, such as to the bottom of lid sections 530A, 530B, 530C, 530D, may be connected to the injection ports for dispensing the liquid across the width of the curvilinear structure 514. The liquid dispensers may be similar in set up to the liquid dispenser shown in FIG. 2. The liquid dispenser is illustrated as being centrally aligned and described as dispensing across the width of the conveyor. It is also possible to vary the lateral position of the liquid dispensers and provide partial side-to-side coverage with multiple dispensers.

An air purge valve may be connected to a liquid manifold. The air purge valve can be opened to provide a flow of compressed air from a compressed air source to purge residual fluid at the end of a treatment cycle. A solvent purge valve may be connected to the liquid manifold. The solvent purge valve can be opened to provide a flow of pressurized solvent from a pressurized solvent source to purge residual fluid at the end of the treatment cycle. The solvent purge flushes residual fluid from the system. This waste solvent mixture may be collected and disposed of. The solvent purge may follow an air purge to minimize the amount of solvent used to clear the system of residual liquid. The solvent used may be water. The control system 130 can be programmed to automatically trigger the solvent purge at the end of a treatment cycle, at the end of an operating day, or upon a shift between liquid sources. The control system 130 may also be programmed to automatically coordinate an air purge and liquid purge.

Fluent materials, such as dry agrochemical additives, including talc or graphite, may be inserted into ports 509A, 509B, 509C, and 509D. For example, a horizontal fluent material dispenser, as disclosed in U.S. patent Ser. No. 15/464,770 “Horizontal Fluent Material Dispenser” filed on 21 Mar. 2020, the disclosure of which is incorporated by reference, may be used that has a conduit extending from the lower portion of the hopper. The conduit, or “stinger,” may be inserted through ports 509A, 509B, 509C, and 509D to dispense the fluent material to the interior portion of the conveyor.

The treatment may be applied to particulate material in an upstream zone of the conveyor while drying occurs in a downstream zone. For example, injection ports 510A, 510B, 510C, and 510D may be made operable with a first treatment source and disposed through removable lid sections 530A and 530B. The zone downstream, corresponding to removable lid sections 530C and 530D, may be made operable with a first conditioning source for cooling and drying of freshly treated seed (best shown in FIG. 4). The zone downstream, corresponding to removable lid sections 530C and 530D, may be made passive for mixing and drying of the treated seed. Alternatively, the zone downstream, corresponding to removable lid sections 530C and 530D, may be connected to a second liquid treatment source containing a second liquid treatment.

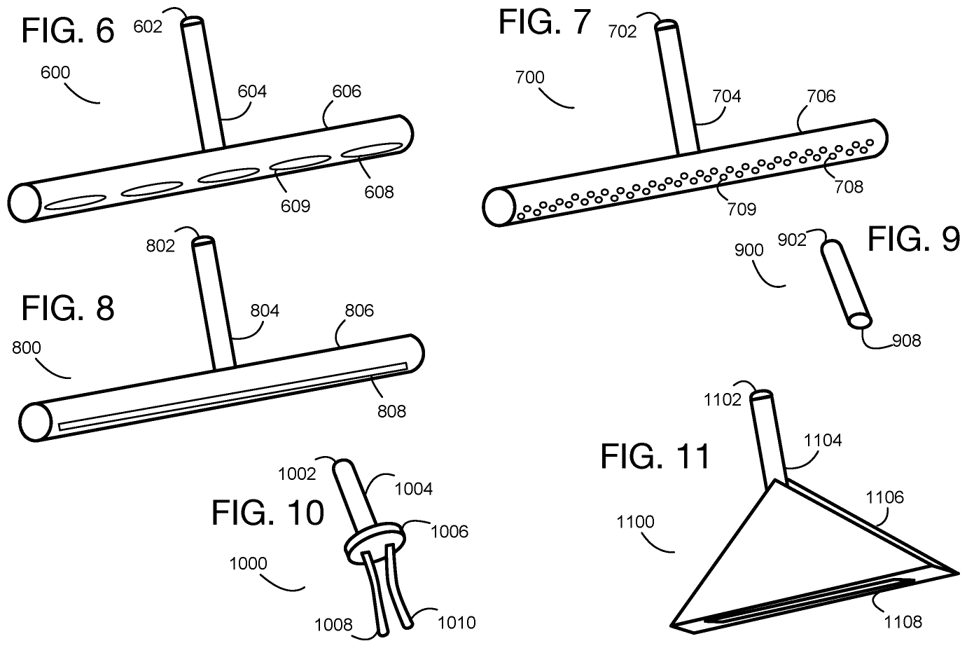

A liquid dispenser 600 for dispensing liquid treatment across the width of the interior portion of the conveyor is shown in FIG. 6. Liquid dispenser 600 includes an upper tube 604 that is hollow and an upper connector 602 for connecting with an injection port that passes through the lid of the conveyor or otherwise passes through a portion of the conveyance structure or enters the interior portion of the conveyor. Tube 606 is hollow and mounted generally horizontally to upper tube 604. A plurality of slots 608, 609 are disposed in a lower portion of the tube 606. Tube 606 may have a length that corresponds to the diameter of the curvilinear structure of the conveyor or to the width of the conveyor. The plurality of slots 608, 609 may extend along the longitudinal length of tube 606, as shown. The longitudinal spacing, number, and size of the slots may depend on the flow rate of the liquid treatment and the viscosity of the intended liquid treatment.

A liquid dispenser 700 for dispensing liquid treatment across the width of the interior portion of the conveyor is shown in FIG. 7. Liquid dispenser 700 includes an upper tube 704 that is hollow and an upper connector 702 for connecting with an injection port that passes through the lid of the conveyor or otherwise passes through a portion of the conveyance structure or enters the interior portion of the conveyor. Tube 706 is hollow and mounted generally horizontally to upper tube 704. A plurality of slots 708, 709 are disposed in a lower portion of the tube 706. Tube 706 may have a length that corresponds to the diameter of the curvilinear structure of the conveyor or to the width of the conveyor. The plurality of slots may extend along the longitudinal length of tube 706, as shown. The longitudinal spacing, number, and size of the slots may depend on the flow rate of the liquid treatment and the viscosity of the intended liquid treatment.

A liquid dispenser 800 for dispensing liquid treatment across the width of the interior portion of the conveyor is shown in FIG. 8. Liquid dispenser 800 includes an upper tube 804 that is hollow and an upper connector 802 for connecting with an injection port that passes through the lid of the conveyor or otherwise passes through a portion of the conveyance structure or enters the interior portion of the conveyor. Tube 806 is hollow and mounted generally horizontally to upper tube 804. A slot 808 is disposed in a lower portion of the tube 806. Tube 806 may have a length that corresponds to the diameter of the curvilinear structure of the conveyor or to the width of the conveyor. Slot 808 may extend along the longitudinal length of tube 806, as shown. The size and length of the slot may depend on the flow rate of the liquid treatment and the viscosity of the intended liquid treatment.

A drop tube 900 for dispensing liquid treatment within the interior portion of the conveyor is shown in FIG. 9. An upper portion 902 may be configured to connect with an injection port that passes through the lid of the conveyor or otherwise passes through a portion of the conveyance structure or enters the interior portion of the conveyor. Drop tube 900 is hollow, allowing liquid to pass therethrough. Drop tube 900 itself can be disposed through the lid, with a liquid connection available for plumbing outside of the conveyor. Drop tube 900 has a lower portion 908 through which the liquid may exit under the force of gravity or under pressure.

A liquid dispenser 1000 for rotary dispensing liquid treatment across a portion of the interior portion of the conveyor is shown in FIG. 10. Liquid dispenser 1000 includes an upper tube 1004 that is hollow an upper connector 1002 for connecting with an injection port that passes through the lid of the conveyor or otherwise passes through a portion of the conveyance structure or enters the interior portion of the conveyor. Disc 1006 may be hollow and rotatably mounted to upper tube 1004. A plurality of slots may be disposed in an outer portion, lower portion, or a combination of both the outer and lower portions of the disc 1006. The plurality of slots may allow the liquid to pass through and exit under centripetal motion with a rotatably mounted disc 1006. Drop tubes 1008, 1010 are hollow and may extend downwardly from disc 1006. Outlet ports at the lower free ends of drop tubes 1008, 1010 allow liquid to exit. Drop tubes 1008, 1010 may be made of a flexible tube material to allow greater spreading of the liquid. Alternatively, disc 1006 may be statically mounted to upper tube 1004, and the spread of the liquid comes solely from the movement of the drop tubes 1008, 1010.

A spreader nozzle 1100 for dispensing liquid treatment across the width of the interior portion of the conveyor is shown in FIG. 11. Spreader nozzle 1100 includes an upper tube 1104 that is hollow and an upper connector 1102 for connecting with an injection port that passes through the lid of the conveyor or otherwise passes through a portion of the conveyance structure or enters the interior portion of the conveyor. Spreader body 1106 is hollow or may have a fluid conduit therethrough. A slot 1108 is disposed in a lower portion of the spreader body 1106. Spreader body 1106 may have a length that corresponds to the diameter of the curvilinear structure of the conveyor or to the width of the conveyor. Slot 1108 may extend along the longitudinal length of spreader body 1106, as shown, or may comprise multiple slots disposed along the width of spreader body 1106. The size, shape, number, and length of the slots may depend on the flow rate of the liquid treatment and the viscosity of the intended liquid.

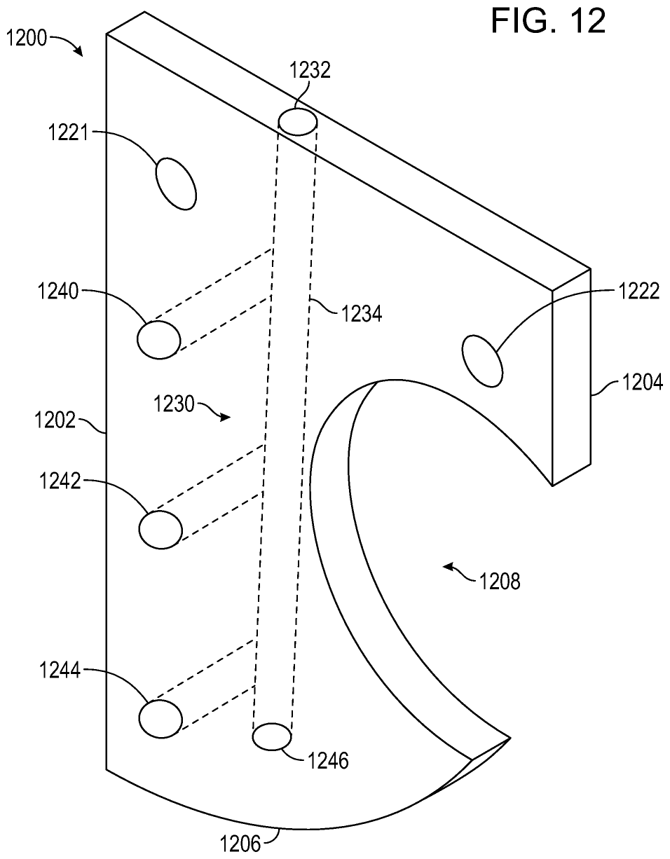

A liquid dispensing mixing baffle 1200 for mixing seed and dispensing liquid treatment within the interior portion of the conveyor is shown in FIG. 12. Liquid dispensing mixing baffle 1200 includes an upper connector 1232 for connecting with an injection port that passes through the lid of the conveyor or otherwise passes through a portion of the conveyance structure or enters the interior portion of the conveyor. Upper connector 1232 may connect directly to the injection port or may use a tube or adapter for such connection. A conduit 1234 is disposed through the liquid dispensing mixing baffle 1200. A plurality of outlet ports 1240, 1242, 1244, and 1246 are disposed in an upstream face of the liquid dispensing mixing baffle, and each of the outlet ports may be in liquid communication with the upper connector 1232 through conduit 1234. Alternatively, the plurality of outlet port may be disposed in a downstream face of the liquid dispensing mixing baffle. The outlet ports may be disposed in a lower portion 1206 of the liquid dispensing mixing baffle 1200. The outlet ports may be disposed in the passage way 1208 of the liquid dispensing mixing baffle 1200. The outlet ports may be disposed along the central edge 1202 of the liquid dispensing mixing baffle 1200. The outlet ports may be disposed along the peripheral edge 1204 of the liquid dispensing mixing baffle 1200. The liquid dispensing mixing baffle 1200 may be mounted to the lid with an L-bracket that is secured to the liquid dispensing mixing baffle 1200 with slots 1221, 1222. The liquid dispenser 1230 of the liquid dispensing mixing baffle 1200 may take a variety of slot sizes, shapes, number, and placement depending at least partially on the flow rate of the liquid treatment, structural stability of the mixing baffle, and the viscosity of the intended liquid.

The tubes of the liquid dispensers described above may be made of stainless steel or other appropriate material. The tubes and drop hoses may be made of material such as copper, plastic hose, or any other tubular material with an open passageway. The tubes may have a diameter between 0.5 cm (approximately ¼ inch) to 1 cm (approximately ⅜ inch).

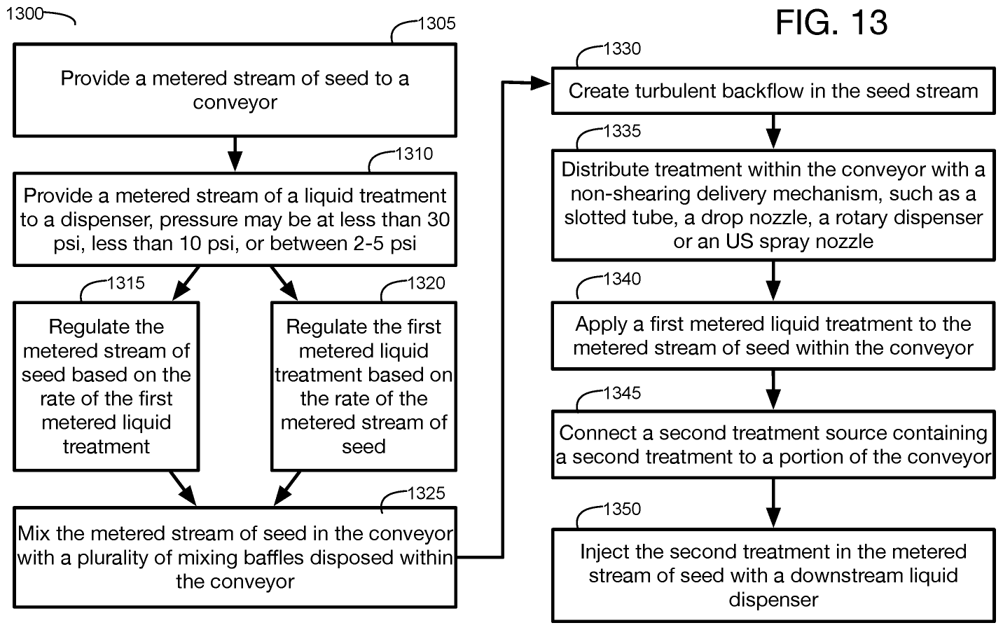

A method 1300 for applying a liquid treatment to seed in an interior portion of a curvilinear conveyor is shown in FIG. 13. A metered stream of seed is provided to the conveyor, according to step 1305. The metering can be volumetric or by weight. For example, the metered stream of seed, such as seed corn, may be between 125 kilograms (300 pounds) per minute and 1,100 kilograms (approximately 2,500 pounds) per minute. The metered rate of seed may depend upon the throughput of the conveyor, which is related to the size of the conveyor, the incline of the conveyor, and the type of material. The metered rate of seed may be determined by a loss-in-weight scale measurement of a hopper 141 or a seed bag or seed box. The metered rate of seed may be determined using a volumetric dispenser, such as a volumetric seed wheel. The seed wheel turns at a measurable or determinable rate, dispensing known quantities of seed over a given time unit. The system maintains that metered rate of seed flow through various components. The conveyor provides a continuous stream of seed flow, maintaining the metered stream of seed when operated without choke feeding or otherwise affecting the metered stream.

The metered stream of a liquid treatment is provided to a liquid dispenser, according to step 1310. The metered stream of liquid treatment may be provided to the dispenser at less than 2,000 mbar or 200,000 Pa (approximately 30 psi), less than 700 mbar or 70,000 Pa (approx. 10 psi), or between 100 mbar or 10,000 Pa to 350 mbar or 35,000 Pa (approx. 2 psi to 5 psi). High pressure systems may create shear, destroying organisms within inoculants. Low pressure delivery systems may prove advantageous to prevent shear for inoculants. Inoculants may include biologicals such as bacteria, mycorrhizal fungus, nematodes, or other beneficial microbes. Jets or nozzles compatible with the liquid treatment may be placed on the end of the couplings to direct liquid treatments.

The metered stream of seed may be regulated based on the rate of the first metered liquid treatment, according to step 1315. For example, the seed flow may be regulated using KSi Conveyor, Inc.'s VariRate® loss-in-weight seed flow control solution with a variable position gate, according to U.S. patent application Ser. No. 13/351,926 “Multi-flow bulk weighing system” filed on 17 Jan. 2012, U.S. patent application Ser. No. 13/958,521 “Seed Flow Rate and Dispersion Pattern Regulator” filed on 2 Aug. 2013, the disclosures of which are incorporated herein by reference, or with a seed wheel. The seed flow rate may be regulated based on the total flow rate of multiple liquids, according to a selected recipe.

Alternatively, the first metered liquid treatment is regulated based on the rate of the metered stream of seed, according to step 1320. This is the preferred regulating step. The first metered liquid treatment may be regulated using a variable flow rate pump under control by the control system 130. The first metered liquid treatment may be regulated using an adjustable rate flow valve based on readings from a mass flow meter, scale, or liquid flow meter.

The metered stream of seed may be mixed in the conveyor using multiple mixing baffles that are mounted within the conveyor, according to step 1325. A turbulent backflow is created in the seed stream, according to step 1330. The turbulent backflow induced by the mixing baffles pushes at least a portion of the seed stream upstream and downhill, disturbing the seed bed. This pre-mix step may allow the liquid treatment to better coat the seed in the seed bed.

The liquid treatment is distributed within the conveyor with a non-shearing delivery mechanism, according to step 1335. Examples of non-shearing delivery mechanisms may include a slotted tube, a drop nozzle, a rotary dispenser, and an ultra-sonic (US) spray nozzle. Low rotation speed rotary dispensers may be preferable to high rotation speed rotary dispensers, to prevent shearing. The liquid treatment may be applied at a rate of between 150 milliliters (mL) (approx. 5 U.S. fluid ounces) per minute to 2.5 liters (L) (approx. 75 U.S. fluid ounces) per minute per dispenser for a conveyor transferring between 125 kilograms (300 pounds) per minute and 1,100 kilograms (approximately 2,500 pounds) per minute. The liquid treatment may be applied at a rate of between 0.5 L (approx. 20 U.S. fluid ounces) per minute to 2 L (approx. 65 U.S. fluid ounces) per minute per dispenser for a conveyor transferring between 125 kilograms (300 pounds) per minute and 1,100 kilograms (approximately 2,500 pounds) per minute. The liquid treatment may be applied at a rate of between 1 L (approx. 40 U.S. fluid ounces) per minute to 1.75 L (approx. 60 U.S. fluid ounces) per minute per dispenser for a conveyor transferring between 125 kilograms (300 pounds) per minute and 1,100 kilograms (approximately 2,500 pounds) per minute.

In a conveyor having a liquid dispensing mixing baffle, steps 1325, 1330, and 1335 may be condensed to a single step, wherein the seed is mixed and the liquid is dispensed through the same contact with the liquid dispensing mixing baffle. Even with the liquid dispensing mixing baffle, the conveyor may contain additional downstream mixing baffles that may or may not be configured for liquid dispensing. Even with the liquid dispensing mixing baffle, the conveyor may contain additional upstream or downstream liquid dispensers.

The first metered liquid treatment is applied to the metered stream of seed within the conveyor, according to step 1340. The liquid is dispensed within the interior portion of the conveyor upon the seed traveling through the interior portion of the conveyor.

A second treatment source may be connected to a downstream injection port, allowing a second treatment to be applied within a second portion of the conveyor, according to step 1345. In this way, a second liquid treatment may be applied as a second coat. The second treatment is injected into the metered stream of seed with a downstream liquid dispenser through a second outlet port, according to step 1350.

The seed treatment source 110 may be a bottle, keg, shuttle (such as a 750 Liter (approx. 200 gallon) shuttle), or tank (such as a 1,250 L (approx. 300 gallon) stainless steel tank). The seed treatment source 110 may be reusable or a single use container.

The pump 114 can be a centrifugal, diaphragm, gear, lobe, peristaltic, progressive cavity, screw, or submersible pump. The pump could also be substituted by pressurizing the liquid in the seed treatment source 110.

To regulate the liquid, the control system 130 controls the pump or the meter. The control system can determine the flow rate of the liquid with meter 116, which may be a volumetric flow meter or a mass flow meter. The control system can also determine the flow rate of the liquid using rate-of-change based on the change in weight signal over time from scale 112. The flow rate is changed by altering the speed of a variable speed pump, or by an adjustable flow rate valve under control of the control system.

A Coriolis mass flow meter may provide real-time density measurements, mass flow rate of liquid treatment, and real time temperature measurements of the liquid. The controller can alert users to temperature measurements of the liquid that are out of an acceptable range. For example, a temperature measurement could indicate increased degradation for an agrochemical, decreased application efficiency, or cell death for a biological treatment. A liquid heating and cooling device could be integrated to compensate for the out of range temperatures. The control system may be configured to change seed treatment application based on the real-time temperature of the liquid agrochemical. The seed treatment parameters comprise: seed flow rate, conditioned air flow rate, conditioned air temperature, conditioned air humidity, flow rate of the liquid seed treatment, heating elements disposed in the supply tank, or application rates of dry products such as talc.

A control system is electrically coupled to the meter, pumps, and liquid flow regulators. The control system is configured to receive an electrical signal generated by the flow meters and scales. The control system is also configured to generate an electric control signal to control the respective flow regulators in response to a recipe. The rate of the metered stream of liquid treatment may be set according to a predefined recipe, selectable using a graphical user interface associated or in communication with the control system.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention. Accordingly, the drawings and detailed description are to be regarded as illustrative in nature and not as restrictive.

1. An agricultural seed conveyor comprising:
a. a conveyance structure comprising:
i. a trough;
b. a belt disposed within the conveyance structure and conformed to the trough; and
c. a liquid dispenser disposed within the conveyance structure and extending laterally across the conveyance structure to distribute a liquid laterally across the conveyance structure.

2. The agricultural seed conveyor of claim 1, further comprising:
a. a plurality of mixing baffles statically disposed within the conveyance structure and laterally adjacent to the liquid dispenser.

3. The agricultural seed conveyor of claim 1, further comprising:
a. a treating zone, being an upstream portion of the conveyance structure having the liquid dispenser; and
b. a drying zone disposed downstream of the treating zone, the drying zone comprising:
i. a gas outlet port disposed within the conveyance structure downstream of the liquid dispenser.

4. The agricultural seed conveyor of claim 2, further comprising:
a. a liquid channel disposed within a first mixing baffle, the liquid channel fluidly connected with a first liquid port.

5. The agricultural seed conveyor of claim 4, further comprising:
a. an outlet port disposed in the first mixing baffle, the outlet port fluidly connected with the liquid channel.

6. The agricultural seed conveyor of claim 1, where the liquid dispenser comprises:
a. a tube comprising:
i. a lower portion; and
ii. a slot disposed in and extending laterally across the lower portion.

7. The agricultural seed conveyor of claim 1, where the liquid dispenser comprises:
a. a tube comprising:
i. a lower portion; and
ii. a plurality of slots disposed in the lower portion.

8. The agricultural seed conveyor of claim 1, further comprising:
a. an injection port through a top portion of the conveyance structure; and
b. a check valve disposed vertically above the injection port and fluidly connected to the liquid dispenser.

9. The agricultural seed conveyor of claim 1, wherein the liquid dispenser is configured to dispense the liquid based on a rate of a metered stream of seed at a pressure of less than 30 pounds per square inch (psi).

10. The agricultural seed conveyor of claim 1, wherein the liquid dispenser is configured to dispense the liquid based on a rate of a metered stream of seed at a pressure of between 2 psi to 5 psi.

11. A method for treating agricultural seed within an agricultural seed conveyor comprising the steps of:
a. transferring a metered stream of seed on a belt conformed to a trough disposed within a conveyance structure;
b. supplying a first metered liquid treatment from a first liquid treatment source to a liquid dispenser, the liquid dispenser disposed within the conveyance structure and extending laterally across a width of the conveyance structure; and
c. distributing the first metered liquid treatment laterally across the conveyance structure to the metered stream of seed based on the rate of the metered stream of seed.

12. The method of claim 11, further comprising the step of:
a. regulating the metered stream of seed based on a measured rate of the first metered liquid treatment.

13. The method of claim 11, further comprising the step of:
a. regulating the first metered liquid treatment based on a measured rate of the metered stream of seed.

14. The method of claim 11, wherein the metered stream of seed is in turbulent backflow when the first metered liquid treatment is distributed.

15. The method of claim 11, further comprising the step of:
a. providing the first metered liquid treatment to the liquid dispenser at less than 30 psi.

16. The method of claim 15, wherein the liquid dispenser is a tube with a lower slot along a length of the tube, where the tube releases a curtain of the first metered liquid treatment across a diameter of the conveyance structure.

17. The method of claim 11, further comprising the step of:
a. providing the first metered liquid treatment to the liquid dispenser at between 2 psi to 5 psi.

18. The method of claim 11, further comprising the step of:
a. connecting a second liquid treatment source to a portion of the conveyance structure; and
b. injecting a second metered liquid treatment in the metered stream of seed with a first outlet port.

19. The method of claim 11, further comprising the step of:
a. distributing the first metered liquid treatment within the conveyance structure with a non-shearing delivery mechanism.

20. The method of claim 11, wherein after the step of distributing, the method further comprises the step of:
a. mixing the first metered liquid treatment through the metered stream of seed with a plurality of static mixing baffles disposed within the conveyance structure and downstream of the liquid dispenser.

21. The method of claim 20, wherein after the step of mixing, the method further comprises the step of:
a. drying the first metered liquid treatment on the metered stream of seed within the conveyance structure downstream of the liquid dispenser.

22. The method of claim 20, wherein after the step of mixing, the method further comprises the step of:
a. introducing pressurized gas into the conveyance structure downstream of the liquid dispenser.

23. The method of claim 20, wherein after the step of mixing, the method further comprises the step of:
a. inducing negative air pressure within the conveyance structure downstream of the liquid dispenser.
